(19) United States
(12) Patent Application Publication
(10) Pub. No.: US 2023/0274516 A1
(43) Pub. Date: Aug. 31, 2023

(54) CONTEXT AWARE DUAL DISPLAY TO AUGMENT REALITY

(71) Applicant: Cognixion Corporation, Santa Barbara, CA (US)

(72) Inventors: Joseph Andreas Forsland, Santa Barbara, CA (US); Leonard Zerman, Santa Barbara, CA (US)

(73) Assignee: Cognixion Corporation, Santa Barbara, CA (US)

(21) Appl. No.: 18/314,380

(22) Filed: May 9, 2023

Related U.S. Application Data
(63) Continuation of application No. 16/749,892, filed on Jan. 22, 2020.
(60) Provisional application No. 62/704,048, filed on Jan. 22, 2019.

(51) Int. Cl. G06T 19/00; G06F 3/14; G02B 27/01; H04N 7/14; G06F 16/383; G06F 3/023

(52) U.S. Cl. CPC G06T 19/006; G06F 3/1454; G02B 27/017; G06F 3/14; H04N 7/14; G06F 16/383; G06F 3/0237

(57) ABSTRACT

A method and system of a user interface device with dual-sided display which may include a system using a brain computer interface with an Augmented Reality (AR) headset. The user's intent is sent to the system, which processes, analyzes and maps the user's intent. An output corresponding to the user's intent is projected using the user interface device. This output is displayed on the user's side of the display. An image corresponding to the output is displayed on the observer's side of the display.

### CROSS-REFERENCE TO RELATED APPLICATIONS

This application is a continuation application of U.S. patent application Ser. No. 16/749,892 filed Jan. 22, 2020, which claims the benefit of U.S. provisional patent application Ser. No. 62/704,048 filed on Jan. 22, 2019, each of which is incorporated herein by reference in its entirety.

### BACKGROUND

Brain-controlled interfaces or augmented reality devices, each including a user interface device, may be utilized by a user to transmit the user's intent (i.e., a desire or plan or accomplish something) or thoughts. The user's intent or thoughts may be received, processed, and mapped to an output corresponding to the user's intent. This output may include an audio, video and the like. However, this output is displayed only to the user wearing the device.

In situations when a user desires to communicate with another person but faces challenges in expressing himself or herself, it may be desirable for the user to display his/her thoughts or intent to an observer.

Therefore, there is a need to provide a system for bi-directional communication that helps the user to communicate effectively and express his/her thoughts clearly and accurately.

### BRIEF SUMMARY

The disclosure includes a method for configuring a user interface device with dual-sided display. The method involves steps including reading the user's intent using a sensor, sending a user's intent to a processing unit, processing, analyzing and mapping the user's intent using the processing unit, projecting an output corresponding to the user's intent using the user interface device, displaying the output on a user's side of the user interface device and displaying a content corresponding to the output on an observer's side of the user interface device.

The disclosure provides a system of a user interface device with a dual-sided display that may include a processor and a memory storing instructions. When these instructions are executed by the processor, the system receives the user's intent from a sensor, sends the user's intent to a processing unit. The processing unit processes, analyzes and maps the user's intent into an output on the user interface device, projects the output using the user interface device, displays the output on a user's side of the user interface device and displays a content corresponding to the output on an observer's side of the user interface device.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a user environment 100 in accordance with one embodiment.

FIG. 2 illustrates a headset 200 in accordance with one embodiment.

FIG. 3 illustrates an augmented reality communication method 300 in accordance with one embodiment.

FIG. 4 illustrates a dual display environment 400 in accordance with one embodiment.

FIG. 5 illustrates an augmented reality communication system 500 in accordance with one embodiment.

FIG. 6 illustrates an augmented reality communication system 600 in accordance with one embodiment.

FIG. 7 illustrates an augmented reality communication method 700 in accordance with one embodiment.

FIG. 8 illustrates a BCI+AR system 800 in accordance with one embodiment.

FIG. 9 illustrates an augmented reality device logic 900 in accordance with one embodiment.

FIG. 10 illustrates a dual display environment 1000 in accordance with one embodiment.

FIG. 11 illustrates a dual display environment 1100 in accordance with one embodiment.

FIG. 12 illustrates a dual display environment 1200 in accordance with one embodiment.

FIG. 13 illustrates a dual display environment 1300 in accordance with one embodiment.

FIG. 14 depicts an illustrative computer system architecture that may be used in accordance with one or more illustrative aspects described herein.

### DETAILED DESCRIPTION

The disclosure relates to configuring a transparent or semi-transparent user interface device to simultaneously display asymmetric content based on the viewing angle. The content is determined based on a user's intent as a data input. The data input may include the user's intent or thoughts, and may be entered directly through a user interface device.

Many “actions” by a source user, (sensor, touch, voice, sound, push-message, Brain-Computer Interface (BCI), etc.) are mapped via the intent and message database to a communication (e.g., “hello”) that is dual-displayed, optionally language translated, or graphically enhanced (i.e., not only raw text) that is observed by both the source user and an outside observer independently.

A transparent or semi-transparent user interface device may be used to simultaneously communicate asymmetric content to an observer and a user. The user interface device may be a dual-sided display on which an image is projected, but through which an observer can see through. A user's intent is mapped to an output that may be displayed to the user on the user's side of the transparent user interface device, while a content corresponding to the user's intent may be displayed to the observer on the observer's side of the transparent user interface device. The content corresponding to the user's intent may include text, images, video or audio and may be asymmetric to what is displayed to the user. The user interface device may include an Augmented Reality (AR) headset, a transparent or semi-transparent screen, an optical projection, or a medium through which a user and observer would still be able to see one another.

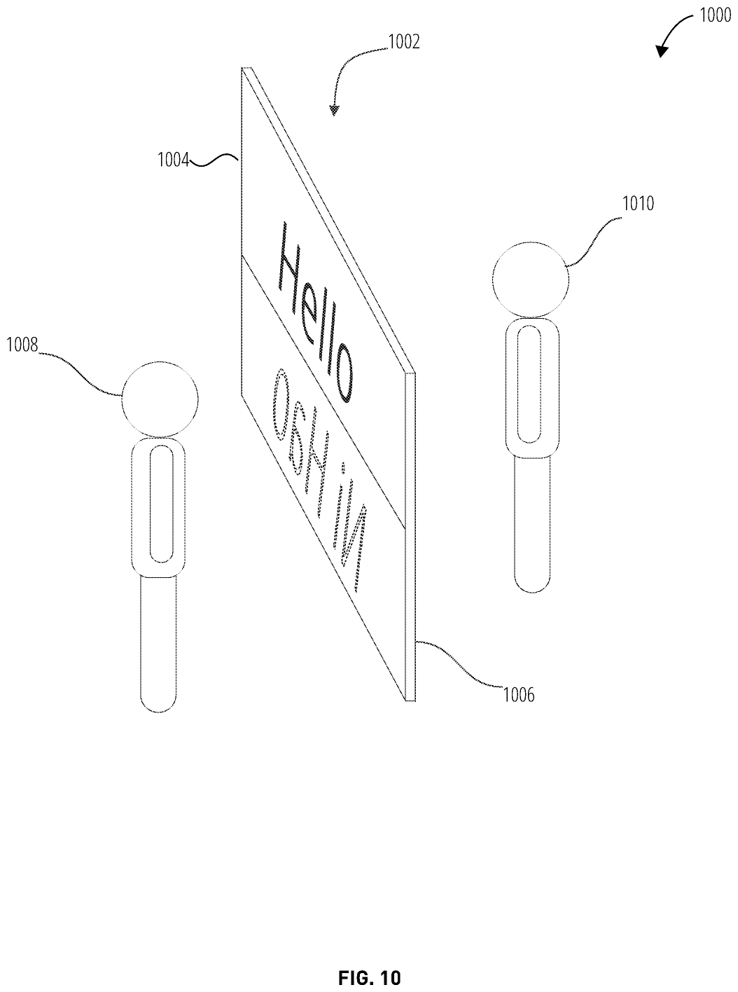

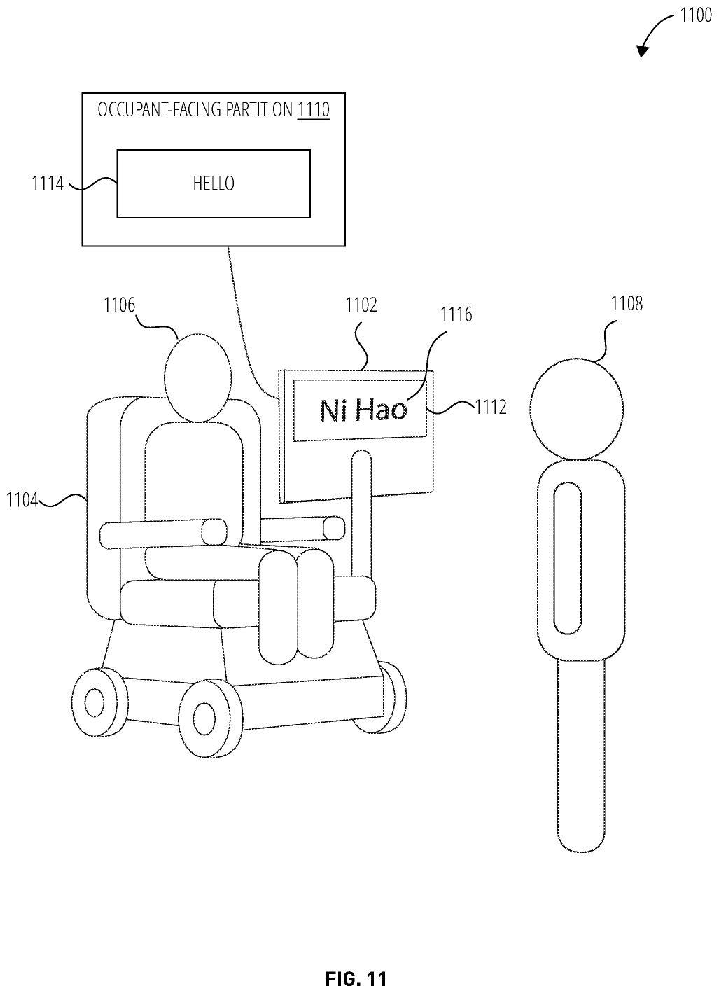

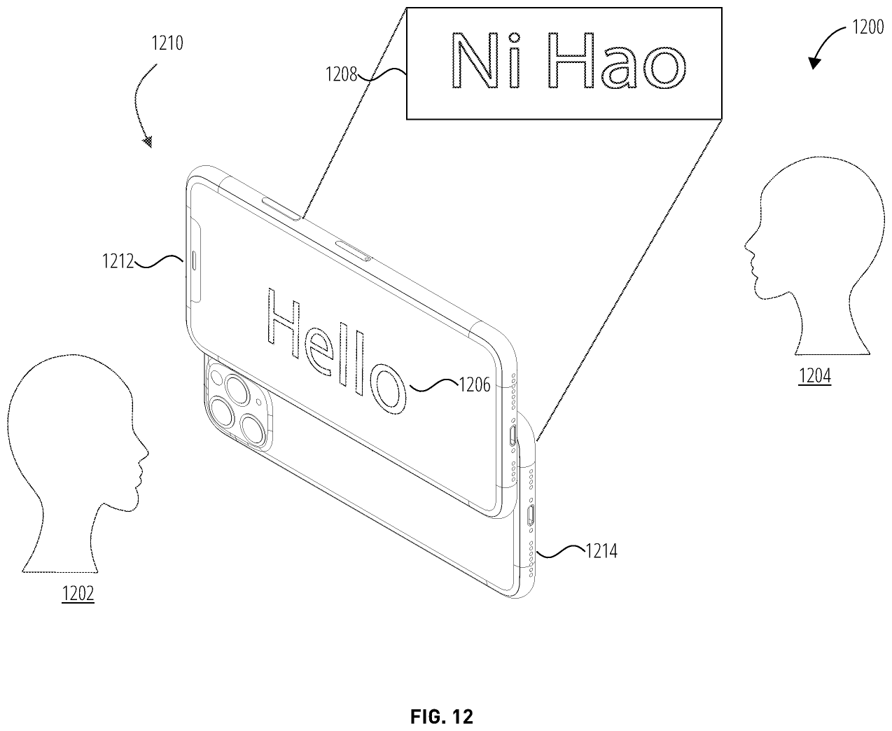

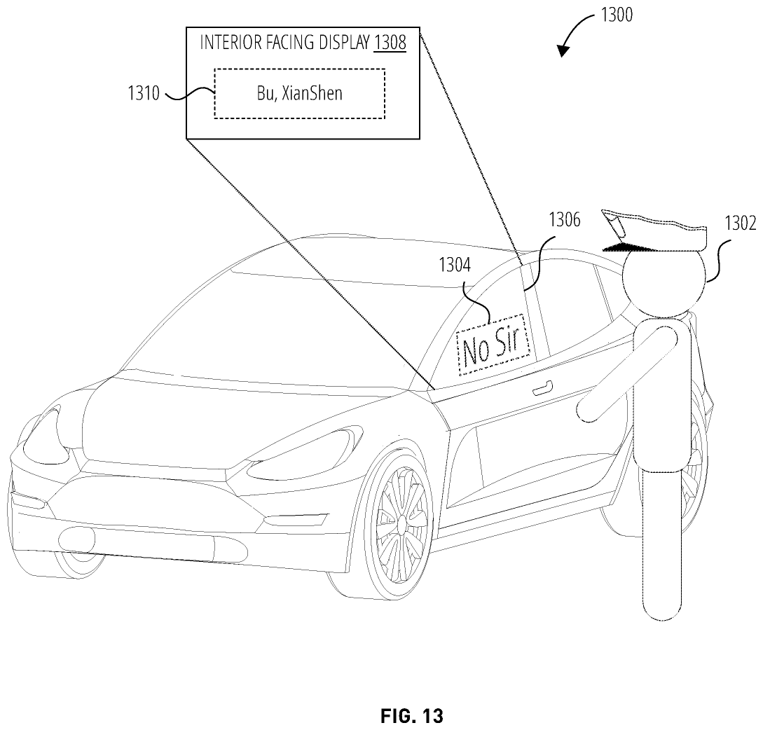

In an embodiment, an intent via a database is mapped to an action that may be displayed to the dual-display but may also be mapped to additional actions. As an exemplary example, speaking the words “Open sesame” (sensor input), if mapped to do so, may open a garage door, a front door to a house, or turn on a light, whatever series of actuations that are mapped to that intent and dual-displayed. In various embodiments, the intent may be a triggering eye-gaze in an AR headset, eye-tracking on to a button on a tablet device, or BCI selection of a steady state visually evoked potential (SSVEP) object, to initiate a control and/or communication. As non-limiting examples in the specification below, various embodiments shown in FIG. 10, FIG. 11, FIG. 12, and FIG. 13 may be entirely speech generated (i.e., the action does not require BCI, touch, an Augmented Reality (AR) headset, etc.).

A method of operating a context aware dual display system involves receiving a signal that represents a user's intent through a sensor or an input device on a user interface device, wherein the user initiates the signal by an activity. The signal may then be sent to an interpretation unit to determine an intent and message from the signal. The intent and message may then be sent to a user interface controller. The user interface controller may then display the intent and message through a user interface device.

The interpretation unit may include a converter, an intent database, a message database, and a comparator. The converter may convert the signal corresponding to the user's intent to a digital signal. The intent database may include intents associated with curated signals. The message database may include messages corresponding to curated intents. The comparator may generate at least one of an intent and a message corresponding to the intent by comparing the digital signal to curated signals in the intent database and by comparing the intent to curated intents in the message database.

In some configurations, the user initiates the signal by the activity that may include at least one of a physical activity, a mental activity, an environmental stimulus, an independently received digital message from a third party (e.g., Apple™ push message), and combinations thereof.

In some configurations, the user's intent includes biosignals comprising at least one of EEG (Electroencephalography), ECG (Electrocardiography), EMG (Electromyography), EOG (Electrooculography), steady state visually evoked potentials, audio evoked potentials, motion evoked potentials, motion based detection, and combinations thereof.

In some configurations, the user interface device comprises at least one of an augmented reality headset, a transparent or semi-transparent screen, an optical projection, a medium through which the user and an observer would see one another and combinations thereof.

In some configurations, the user interface controller may select to display at least one of the intent, the message and combinations thereof.

In some configurations, the sensor is at least one of a biometric sensor attached to a user's body, an accelerometer, and a camera tracking a user's eye movements.

In some configurations, the context aware dual display system may display the intent to a contextually related display. A “Contextually related display” refers to a display device with a set of physical and cognitive factors that determine the meaning of an otherwise ambiguous element(s) associated with those factors. The contextually related display may be a portion of a semi-transparent screen on the user interface device.

In some configurations, the signal may be a request to display a virtual keyboard on the user interface device. The inputs from the virtual keyboard may initiate a command to communicate to an observer.

In some configurations, the method may involve receiving a communication from a third party and displaying the communication to a contextually related display.

In some configurations, the method may involve determining if the intent database and the message database include a desired intent or a desired message, wherein at least one of the intent database and the message database is located on the user interface device. In some instances, at least one of the intent database and the message database may be located on a cloud server or local edge computing device (i.e., data is processed by the device itself or by a local computer or server, rather than being transmitted to a data center or cloud server). In some instances, the method may further involve updating at least one of the intent database and the message database with the desired intent or the desired message.

A computing apparatus may include a processor and memory storing instructions that, when executed by the processor, configure the apparatus to perform certain actions. The instructions may configure the apparatus to receive a signal that represents a user's intent through a sensor on a user interface device, wherein the user initiates the signal by an activity. The instructions may configure the apparatus to send the signal to an interpretation unit to determine an intent and message from the signal. The instructions may configure the apparatus to send the intent and the message to a user interface controller to display the intent and the message. The instructions may configure the apparatus to display the intent and the message on the user interface device.

The interpretation unit may include a converter, an intent database, a message database, and a comparator. The converter may convert the signal corresponding to the user's intent to a digital signal. The intent database may include intents associated with curated signals. The message database may include messages corresponding to curated intents. The comparator may generate at least one of an intent and a message corresponding to the intent by comparing the digital signal to curated signals in the intent database and by comparing the intent to curated intents in the message database.

In some configurations, the user interface device may include at least one of an augmented reality headset, a transparent or semi-transparent screen, a medium through which the user and an observer would see one another and combinations thereof. In some configurations, the transparent or semi-transparent screen may be a transparent organic light emitting diode (TOLED) screen or projection on a semi-reflective medium. In some configurations, the transparent or semi-transparent screen may be replaced by two non-transparent displays, wherein the two non-transparent displays show contextually related information.

In some configurations, the user interface controller may select to display at least one of the intent, the message and combinations thereof.

In some configurations, the user may initiate the signal by the activity that may include at least one of a physical activity, a mental activity, and environmental stimulus, an independently received digital message from a third party (e.g., APPLE™ push message), and combinations thereof.

Computer software, Hardware, and networks may be utilized in a variety of different system environments, including standalone, networked, remote-access (aka, remote desktop), virtualized, and/or cloud-based environments, among others.

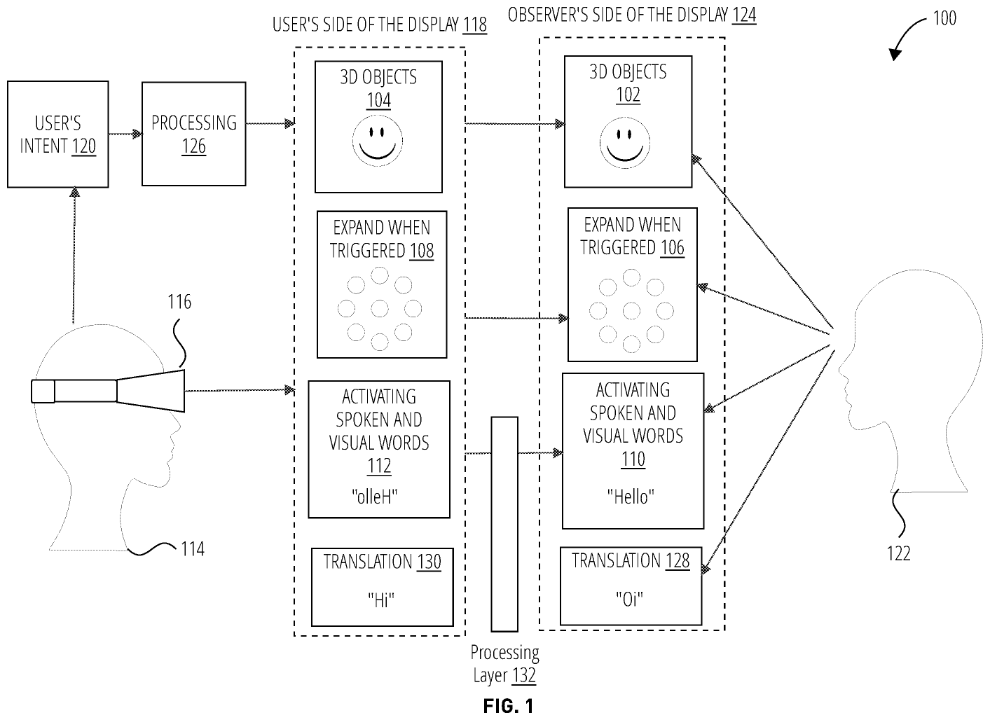

FIG. 1 shows an environment 100 that includes a human user 114 wearing a user interface device 116 and an observer 122. The user's intent 120 is sent to processing 126, and an output corresponding to the intent is displayed for the user and the observer. The user's intent may be displayed on user's side of the display 118 and a content associated with the user's intent 120 may be displayed on the observer's side of the display 124. The observer's side of the display 124 may include examples such as 3D objects 102, expand when triggered 106 objects, an activating spoken and visual words 110 display or sound, and the like. The user's side of the display 118 may include 3D objects 104, expand when triggered 108 objects, and an activating spoken and visual words 112 display or sound. Thus, a bi-directional communication is possible.

The user's intent may include a biosignal such as EEG (Electroencephalography), ECG (Electrocardiography), EMG (Electromyography), EOG (Electrooculography), steady state visually evoked potentials, steady state audio evoked potentials, motion evoked potentials, motion detection such as derived from a gyroscope, accelerometer or magnetometer input, and the like.

In one embodiment, when a user sees a flashing light, the system processes what the user sees and gives a corresponding output. For example, if the flashing light is “green” in color and it is associated with “happy”, then the display on the user's side may show the text “happy” and the display on the observer's side may show a 3D image that corresponds to “happy.” In one embodiment, the visual word may appear correctly to observer 122, e.g., “Hello” and as a mirror image, e.g., “olleH” to the human user 114.

In one embodiment, a user generates a greeting expression of “Hello” and the user preference is set for informal communication style. The message may be displayed to the user in their native language (e.g., English=“Hi”)(translation 130). The observer may see the expression in their native language (e.g., Portuguese=“Oi”)(translation 128). The translation may be performed by a processing layer 132 that captures activating spoken and visual words 112 for translation and displays the translation 128 on the observer's side of the display 124.

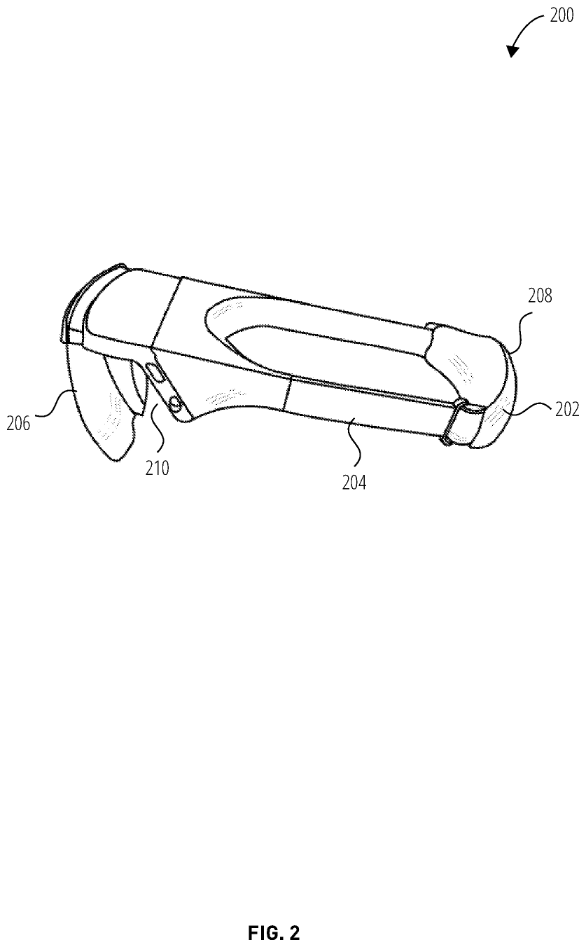

In an embodiment as seen in FIG. 2, a headset 200 comprises a user interface device 202, a strap 204, a display 206, a contoured sleeve 208, and a display projector 210, however the headset 200 is not limited thereto. The user interface device 202 may be curved in shape to contour around the back of a human head. The user interface device 202 may include a printed circuit board. In some embodiments, the printed circuit board is contoured to confirm to a user's head. The contoured sleeve 208 holds the user interface device 202 and other items such as batteries. The strap 204 may go around the user interface device 202 to wrap around the human head and hold it in contact with the human head. In some embodiments, the strap 204 runs through the contoured sleeve 208, however, the strap 204 may also run on the outside rear surface of the contoured sleeve 208. The strap 204 may connect the user interface device 202 electrically and physically to the display 206 and the display projector 210. The user interface device 202 may send a video signal to a user through the display projector 210 and display 206. In some embodiments, the display 206 displays Augmented Reality (AR) images. One of skill in the art will realize that any headset capable of AR and the ability to project images to a display that may be observed by a user and an observer may be used.

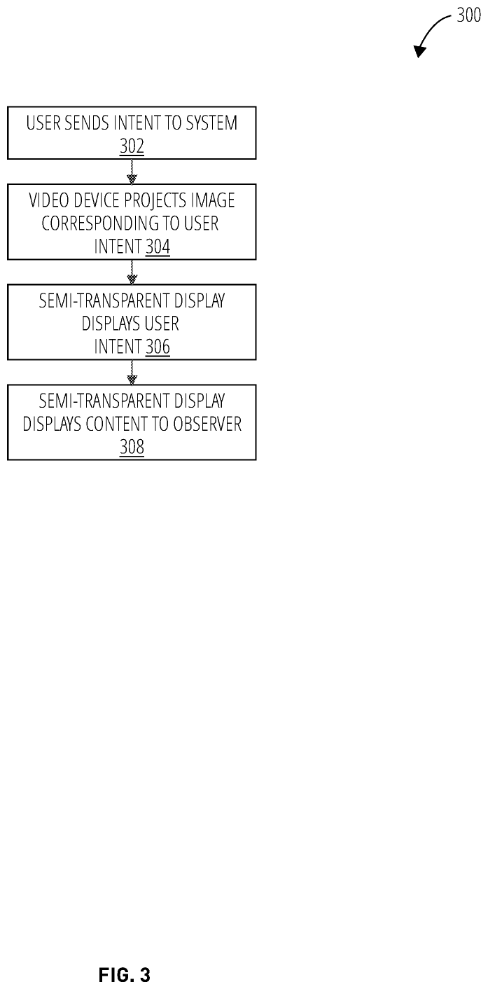

FIG. 3 shows a method 300 that includes the steps involved in configuring a transparent user interface to simultaneously display content based on the user's intent in an embodiment of the disclosure. The steps include sending a user's intent to a system using brain computer interface (block 302), projecting an image corresponding to user intent (block 304), displaying user's intent on the user side of the display (block 306) and displaying a content to an observer on the observer's side of the user interface (block 308).

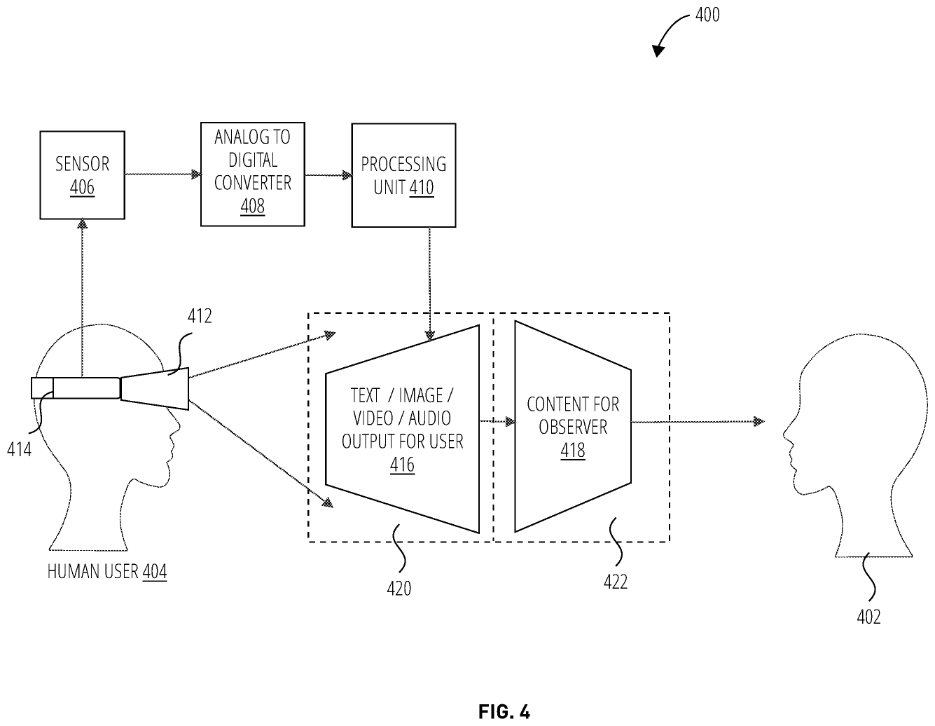

FIG. 4 illustrates an embodiment of a dual display environment 400. The dual display environment 400 comprises a sensor 406, an analog to digital converter 408, a processing unit 410, a text/image/video/audio output for user 416, a display 412, a human user 404 wearing a headset 414 which includes a brain computer interface, a user's side of the display 420, an observer's side of the display 422, a content for observer 418 and an observer 402.

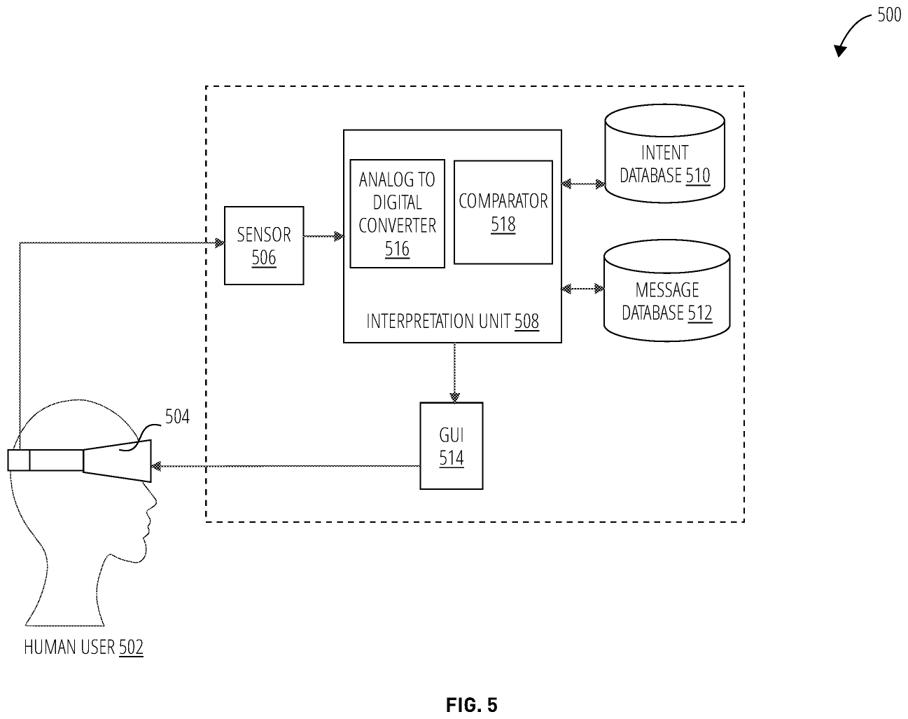

A human user 404 interacts with the environment, the sensor 406 reads the user's intent and triggers the operating system. The analog to digital converter 408 receives the sensor 406 output (e.g., user's intent). The analog to digital converter 408 transforms the sensor output into a digital signal which is sent to a processing unit 410. The signal is then processed using, for example, the system described in FIG. 5, analyzed and mapped to a text/image/video/audio output for user 416 and displayed on the display 412. Further, a content for observer 418 related to the text/image/video/audio output for user 416 is displayed on the display 412.

FIG. 5 shows a block diagram of a system 500 including a user 502 wearing a user interface device 504. The system 500 may include a sensor 506, an interpretation unit 508 and a user interface controller 514.

The interpretation unit 508 may include a converter 516, a comparator 518, an intent database 510 and a message database 512.

In an embodiment, when the user interacts with a physical surface, physical document, virtual document and the like in an environment, his mental or physical activity may generate brain signals that trigger the sensor 506. These analog signals may be received by the sensor 506 and sent to the interpretation unit 508. The interpretation unit 508 converts the received signal to a digital signal using an analog to digital converter 516. The comparator 518 generates an intent and a message, by comparing the digital signal to curated signals in the intent database 510 and by comparing the intent to curated intents in the message database 512. The intent and the message may then be sent to a user interface controller, such as a graphical user interface controller 514. The user interface controller may provide display options to the user such as to display the intent and the message on one side, other side or both the sides of the user interface device. Depending upon the selected option, the intent, the message or both may be displayed on the user interface device 504. For example, the user may initiate a signal by eye movements, viewing certain colors or shapes and the like.

Examples of a user interface device 504 may include an augmented reality headset, a transparent or semi-transparent screen, an optical projection, a medium through which the user and the observer would see one another and the like.

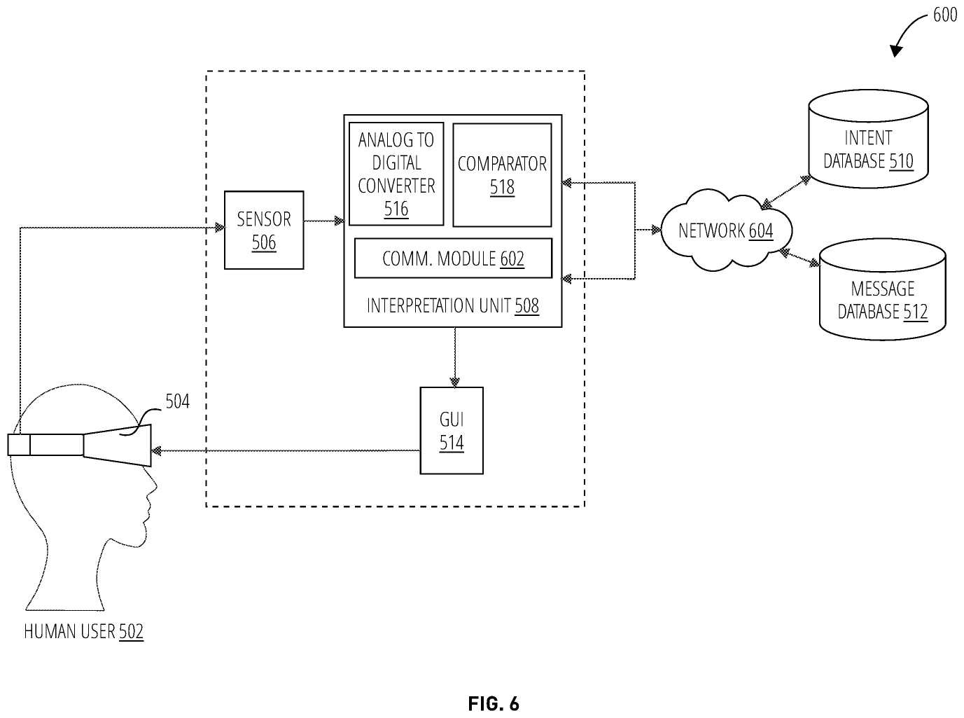

In accordance with one embodiment, FIG. 6 illustrates a system 600 comprising a user 502 wearing a user interface device 504. The user interface device 504 comprises a sensor 506, an interpretation unit 508, and a user interface controller 514. The sensor 506 may be utilized to detect an analog signal from the user and communicate the signal to the interpretation unit 508. The interpretation unit 508 transforms the user 502's analog signal into a digital signal through a converter 516. The digital signal may then be utilized by a comparator 518 to determine an intent and or a message from an intent database 510 and/or a message database 512. In some configurations, the intent database 510 and the message database 512 may be accessible across a network 604 by way of a communications module 602 within the interpretation unit 508. After an intent and/or message has been identified by the comparator 518, the intent or message may be displayed through a user interface controller 514.

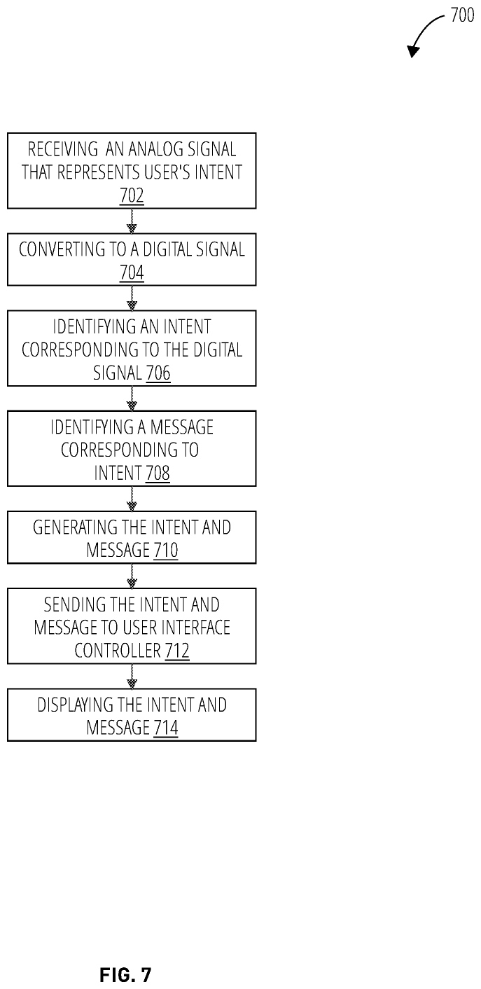

According to embodiments of the disclosure, FIG. 7 shows a method 700 for displaying a user's intent on the user interface device. The steps may involve receiving an analog signal that represents a user's intent (block 702), converting the analog signal to a digital signal (block 704), identifying an intent corresponding to the digital signal (block 706), identifying a message corresponding to intent (block 708), generating the intent and message (block 710), sending the intent and message to user interface controller (block 712) and displaying the intent and the message on the user interface device (block 714).

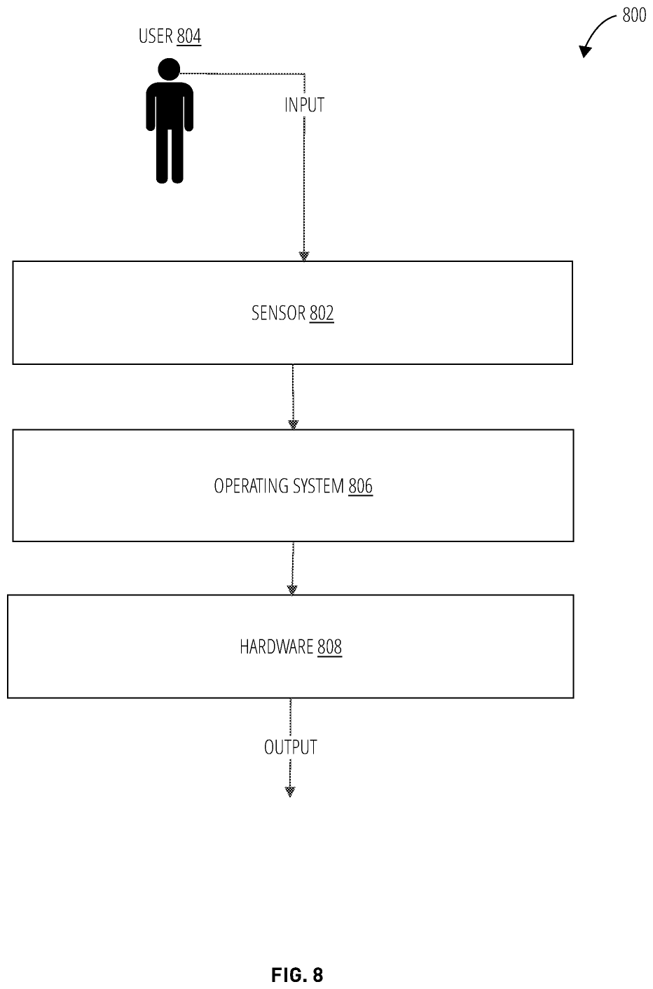

FIG. 8 shows a BCI+AR system 800 in accordance with embodiments of the disclosure. A sensor 802 receives signals from a user 804. These signals trigger an event in the operating system 806. The signals are then mapped to an output using the Hardware 808. The output may include audio and video or may be a haptic output including haptic vibrations.

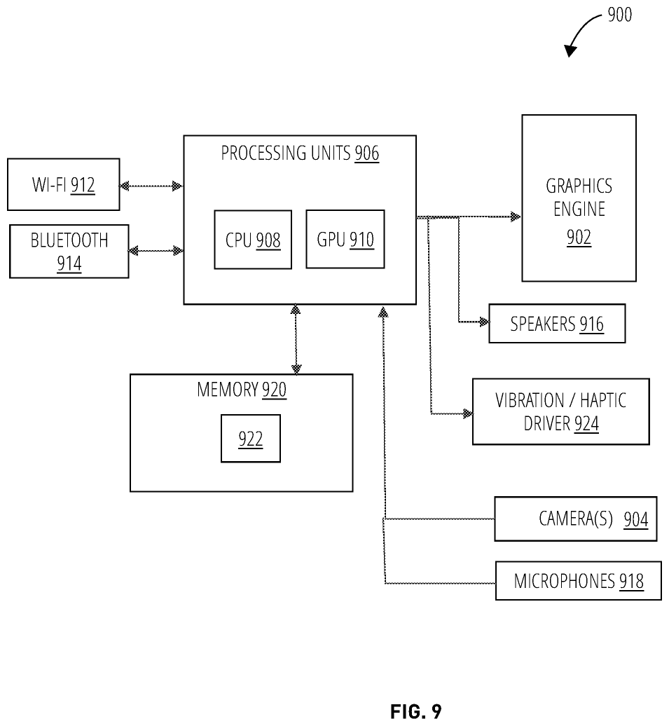

FIG. 9 illustrates components of an exemplary augmented reality device logic 900 according to embodiments of the disclosure. The augmented reality device logic 900 comprises a graphics engine 902, a camera(s) 904, processing units 906, including one or more CPU 908 and/or GPU 910, a Wi-Fi 912 wireless interface, a Bluetooth 914 wireless interface, speakers 916, microphones 918, one or more memory 920, logic 922, and vibration/haptic driver 924.

The processing units 906 may in some cases comprise programmable devices such as bespoke processing units optimized for a particular function, such as AR related functions. The augmented reality device logic 900 may comprise other components that are not shown, such as dedicated depth sensors, additional interfaces, etc.

Some or all of the components in FIG. 9 may be housed in an AR headset. In some embodiments, some of these components may be housed in a separate housing connected to or in wireless communication with the components of the AR headset. For example, a separate housing for some components may be designed to be worn on a belt or to fit in the wearer's pocket, or one or more of the components may be housed in a separate computer device (smartphone, tablet, laptop or desktop computer etc.), which communicates wirelessly with the display and camera apparatus in the AR headset, whereby the headset and separate device constitute the full augmented reality device logic 900.

The memory 920 comprises logic 922 to be applied to the processing units 906 to execute. In some cases, different parts of the logic 922 may be executed by different components of the processing units 906. The logic 922 typically comprises code of an operating system, as well as code of one or more applications configured to run on the operating system to carry out aspects of the processes disclosed herein.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

FIG. 10 illustrates an embodiment of a dual display environment 1000. In the dual display environment 1000 a user 1010 and a user 1008 are positioned on opposite sides of a contextually related display 1002. The contextually related display 1002 may be a transparent or semi-transparent screen that allows the users to view each other during their conversation. The user 1008 may greet to the user 1010 by saying “Hello” and the message may be shown to the user 1008 on a partition 1006 of the contextually related display 1002. On the opposite portion of the contextually related display 1002, the user 1010 may be shown the translation of the greeting on the partition 1004 of the contextually related display 1002.

FIG. 11 illustrates an embodiment of a dual display environment 1100. The dual display environment 1100 may include a contextually related display 1102 mounted on a mobility device 1104 such as (but not limited to) a wheel chair, as shown. In the dual display environment 1100 a user 1106 and a user 1108 are positioned on opposite sides of a contextually related display 1102. The user 1106 may be seated in the mobility device 1104 while the user 1108 faces them, able to read the side of the contextually related display 1102 opposite the user 1106. The contextually related display 1102 may be opaque in part or whole, and may be mounted in a position that allows the users to view each other as well as their portion of the contextually related display 1102.

The user 1106 may greet the user 1108 by saying “HELLO,” and this message 1114 may be shown to the user 1106 on an occupant-facing partition 1110 of the contextually related display 1102. On the opposite side of the contextually related display 1102, the user 1108 may be shown the translated message 1116 (e.g., “Ni Hao”) on the outward-facing partition 1112 of the contextually related display 1102.

FIG. 12 illustrates an embodiment of a dual display environment 1200. The dual display environment 1200 may include two user interface devices (user interface device 1212 and user interface device 1214) serving as the contextually related displays 1210. The two user interface devices may be positioned such that their backs are positioned against one another and their screens are facing a user. For instance, the user interface device 1212 may be positioned with the screen directed towards the first user 1202, while the user interface device 1214 may be positioned with the screen directed towards the second user 1204. The first user 1202 may communicate a message 1206 (e.g., “Hello”) that may appear on the screen of the user interface device 1212. The message may be translated and appear on the screen of the user interface device 1214 as the translation 1208 (e.g., “Ni Hao”).

FIG. 13 illustrates an embodiment of a dual display environment 1300 where a contextually related display 1306 is integrated into the driver side window of a vehicle. In this environment, a user may be speaking with a police officer (user 1302) while seated in the vehicle. The user may communicate a message to the police officer that shows up on the Interior facing display 1308 of the contextually related display 1306 as the message 1310. The contextually related display 1306 may then display a translation 1304 towards the user 1302 of the message 1310. In this scenario, the contextually related display 1306 may translate message between the user within the vehicle and the user 1302, such that the interior facing display 1308 may show the translations from the user 1302 while showing the user 1302 the communicated message.

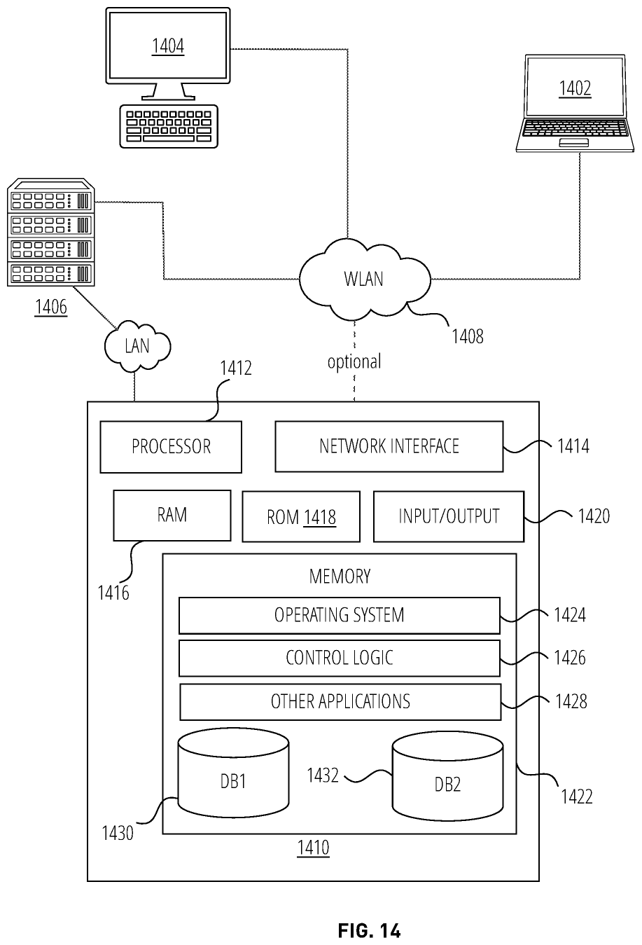

FIG. 14 illustrates one example of a system architecture and data processing device that may be used to implement one or more illustrative aspects described herein in a standalone and/or networked environment. Various network nodes data server 1410, web server 1406, computer 1404, and laptop 1402 may be interconnected via a wide area network 1408 (WAN), such as the internet. Other networks may also or alternatively be used, including private intranets, corporate networks, LANs, metropolitan area networks (MANs) wireless networks, personal networks (PANs), and the like. Network 1408 is for illustration purposes and may be replaced with fewer or additional computer networks. A local area network (LAN) may have one or more of any known LAN topology and may use one or more of a variety of different protocols, such as ethernet. Devices data server 1410, web server 1406, computer 1404, laptop 1402 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1410, web server 1406, and client computer 1404, laptop 1402. Data server 1410 provides overall access, control and administration of databases and control software for performing one or more illustrative aspects described herein. Data server data server 1410 may be connected to web server 1406 through which users interact with and obtain data as requested. Alternatively, data server 1410 may act as a web server itself and be directly connected to the internet. Data server 1410 may be connected to web server 1406 through the network 1408 (e.g., the internet), via direct or indirect connection, or via some other network. Users may interact with the data server 1410 using remote computer 1404, laptop 1402, e.g., using a web browser to connect to the data server 1410 via one or more externally exposed web sites hosted by web server 1406. Client computer 1404, laptop 1402 may be used in concert with data server 1410 to access data stored therein, or may be used for other purposes. For example, from client computer 1404, a user may access web server 1406 using an internet browser, as is known in the art, or by executing a software application that communicates with web server 1406 and/or data server 1410 over a computer network (such as the internet).

Servers and applications may be combined on the same physical machines, and retain separate virtual or logical addresses, or may reside on separate physical machines. FIG. 14 illustrates just one example of a network architecture that may be used, and those of skill in the art will appreciate that the specific network architecture and data processing devices used may vary, and are secondary to the functionality that they provide, as further described herein. For example, services provided by web server 1406 and data server 1410 may be combined on a single server.

Each component data server 1410, web server 1406, computer 1404, laptop 1402 may be any type of known computer, server, or data processing device. Data server 1410, e.g., may include a processor 1412 controlling overall operation of the data server 1410. Data server 1410 may further include RAM 1416, ROM 1418, network interface 1414, input/output interfaces 1420 (e.g., keyboard, mouse, display, printer, etc.), and memory 1422. Input/output interfaces 1420 may include a variety of interface units and drives for reading, writing, displaying, and/or printing data or files. Memory 1422 may further store operating system software 1424 for controlling overall operation of the data server 1410, control logic 1426 for instructing data server 1410 to perform aspects described herein, and other application software 1428 providing secondary, support, and/or other functionality which may or may not be used in conjunction with aspects described herein. The control logic may also be referred to herein as the data server software control logic 1426. Functionality of the data server software may refer to operations or decisions made automatically based on rules coded into the control logic, made manually by a user providing input into the system, and/or a combination of automatic processing based on user input (e.g., queries, data updates, etc.).

memory 1422 may also store data used in performance of one or more aspects described herein, including a first database 1432 and a second database 1430. In some embodiments, the first database may include the second database (e.g., as a separate table, report, etc.). That is, the information can be stored in a single database, or separated into different logical, virtual, or physical databases, depending on system design. Web server 1406, computer 1404, laptop 1402 may have similar or different architecture as described with respect to data server 1410. Those of skill in the art will appreciate that the functionality of data server 1410 (or web server 1406, computer 1404, laptop 1402) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in Software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has Circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C. § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

Terms used herein should be accorded their ordinary meaning in the relevant arts, or the meaning indicated by their use in context, but if an express definition is provided, that meaning controls.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, systems, methods and media for carrying out the several purposes of the disclosed subject matter. It is important, therefore, that the claims be regarded as including such equivalent constructions insofar as they do not depart from the spirit and scope of the disclosed subject matter.

What is claimed is:

1. A method comprising:
receiving a signal that represents a user's evoked potential through a sensor or an input device on a user interface device, wherein the user initiates the signal by an activity;
sending the signal to an interpretation unit, wherein the interpretation unit comprises:
a converter, wherein the converter converts the signal corresponding to the user's evoked potential to a digital signal;
an intent database, wherein the intent database includes actions associated with curated digital signals;
a message database, wherein the message database includes messages corresponding to curated actions; and
a comparator, wherein the comparator generates at least one of a user-initiated action and a message corresponding to the user-initiated action by comparing the digital signal to the curated digital signals in the intent database to generate the user-initiated action and by comparing the user-initiated action to curated actions in the message database to generate the message;
sending the user-initiated action and the message to a user interface controller to display the user-initiated action and the message; and
displaying the user-initiated action and the message on the user interface device.

2. The method of claim 1, wherein the user initiates the signal by the activity that may include at least one of a physical activity, a mental activity, an environmental stimulus, and combinations thereof.

3. The method of claim 1, wherein the user interface device comprises at least one of an augmented reality headset, a transparent or semi-transparent screen, an optical projection, a medium through which the user and an observer would see one another and combinations thereof.

4. The method of claim 1, wherein the user interface controller may select to display at least one of the user-initiated action, the message and combinations thereof.

5. The method of claim 1, further comprising displaying the user-initiated action to a contextually related display to an observer.

6. The method of claim 5, wherein the contextually related display is a portion of a transparent, semi-transparent, or projected screen on the user interface device.

7. The method of claim 1, wherein the signal is a request to display a virtual keyboard on the user interface device.

8. The method of claim 7, further comprising initiating a command from the virtual keyboard to communicate to an observer.

9. The method of claim 1, further comprising receiving a communication from a third party and displaying the communication to a contextually related display.

10. The method of claim 1, further comprising determining if the intent database and the message database include a desired action or a desired message, wherein at least one of the intent database and the message database is located on the user interface device.

11. The method of claim 10, wherein at least one of the intent database and the message database is located on a cloud server or local edge computing device.

12. The method of claim 10, further comprising updating at least one of the intent database and the message database with the desired action or the desired message.

13. An apparatus comprising:
a processor; and
a memory storing instructions that, when executed by the processor, configure the apparatus to:
receive a signal that represents a user's evoked potential through a sensor on a user interface device, wherein the user initiates the signal by an activity;
send the signal to an interpretation unit; wherein the interpretation unit comprises:
a converter, wherein the converter converts the signal corresponding to the user's evoked potential to a digital signal;
an intent database, wherein the intent database includes actions associated with curated digital signals;
a message database, wherein the message database includes messages corresponding to curated actions; and
a comparator, wherein the comparator generates at least one of a user-initiated action and a message corresponding to the user-initiated action by comparing the digital signal to curated digital signals in the intent database to generate the user-initiated action and by comparing the user-initiated action to curated actions in the message database to generate the message;
send the user-initiated action and the message to a user interface controller to display the user-initiated action and the message; and
display the user-initiated action and the message on the user interface device.

14. The apparatus of claim 13, wherein the user interface device comprises at least one of an augmented reality headset, a transparent or semi-transparent screen, an optical projection, a medium through which the user and an observer would see one another and combinations thereof.

15. The apparatus of claim 14, wherein the transparent or semi-transparent screen is a transparent organic light emitting diode (TOLED) screen or a projection on a semi-reflective medium.

16. The apparatus of claim 14, wherein the transparent or semi-transparent screen is replaced by two non-transparent displays, wherein the two non-transparent displays show contextually related information.

17. The apparatus of claim 13, wherein the user interface controller may select to display at least one of the user-initiated action, the message and combinations thereof.

18. The apparatus of claim 13, wherein the user initiates the signal by the activity that may include at least one of a physical activity, a mental activity, an environmental stimulus, an independently received digital message, and combinations thereof.
